(19) United States
(12) Patent Application Publication
(10) Pub. No.: US 2026/0107245 A1
(43) Pub. Date: Apr. 16, 2026

(54) TEXT MESSAGE FORWARDING ACROSS MULTIPLE WIRELESS NETWORKS

(71) Applicant: Charter Communications Operating, LLC, St. Louis, MO (US)

(72) Inventor: Venkata R. Divvi, Centennial, CO (US)

(21) Appl. No.: 18/912,944

(22) Filed: Oct. 11, 2024

(51) Int. Cl. H04W 60/04; H04W 74/0816; H04W 76/10

(52) U.S. Cl. CPC H04W 60/04; H04W 74/0816; H04W 76/10

(57) ABSTRACT

A communication management resource in any network environment detects first wireless connectivity between a mobile communication device and a second wireless network. The communication management resource provides notification of the first wireless connectivity to a first wireless network. The first wireless network is operative to control forwarding of text messages to the mobile communication device. In response to providing the notification, the communication management resource receives a first text message redirected by the first wireless network to the second wireless network for delivery of the first text message through the second wireless network to the mobile communication device.

### BACKGROUND

Conventional multi-factor authentication is commonly used to add an extra security layer for securing access to critical resources like online banking websites, e-commerce portals, enterprise applications, etc. To gain access to respective applications, the end-user must provide more than one valid distinct credential in a short time duration. For example, an end-user may attempt to execute an application. A server resource can be configured to communicate a password to the end-user on a device separate from the device used to execute or access the application. The user supplies the password within a time limit to use the application.

More specifically, at the time of account registration, an end user typically is able to choose one or more subsequent authentication methods, in addition to a primary authentication credential such as a primary username and primary password. As an example, a bank application portal or other suitable entity can be configured to prompt a communication device for a primary user username and primary password for first-round authentication. Upon successful first-round authentication, the bank application portal in this example may prompt a respective communication device for subsequent authentication. This may include the respective system sending a code (such as a so-called OTP: One-Time-Password) to the mobile phone number associated with the respective account. The end users and corresponding communication devices must then submit that OTP as second-level authentication input to the prompt displayed by the portal within a stipulated time window.

### BRIEF DESCRIPTION

This disclosure includes the observation that conventional multi-factor authentication suffers from deficiencies. For example, in the above specific example implementing two-factor authentication, a OTP (a.k.a., One Time Password) is time-sensitive and typically delivered to the end user using text messaging protocols (SMS: Short Message Service) over wide-area wireless networks (cellular networks) such as 2G/3G/4G/5G. Unfortunately, the delivery of the time-sensitive OTP text messages using SMS may fail in certain situations, negatively impacting the end-user experience such as preventing the use of corresponding applications. Failure of receiving a text message may occur in situations such as: i) where wide area wireless network coverage is not able to deliver a respective text message due to the end user being on a cell edge, ii) new-generation wireless networks operating on higher frequency bands (e.g. 5G), have different propagation outcomes to different media. For example, a closed door or thick glass used in high-rise buildings may result in no/low signal coverage inside a respective building, iii) service providers opt to offload the end user data to other alternative wireless networks like Wi-Fi™, to save the precious wide area wireless resources and/or cost-saving measures.

It is noted that a wireless network such as a Wi-Fi™ network may be heavily used for better wireless coverage, especially for indoor scenarios like those listed above. Service providers may deploy the managed Wi-Fi™ network as a cost-effective data offloading alternative, that allows end user to get Internet access. Some existing implementations and solutions allow end users to exchange test messages over Wi-Fi with many limitations and are not device and operator agnostic.

Techniques herein provide novel ways of providing improved wireless communications to one or more mobile communication devices in a network environment via unique control of wireless bandwidth provided in a network environment. In one example, the techniques herein include a device-agnostic solution for delivery of time-sensitive text message delivery (such as to convey multi-factor authentication codes or other sensitive information) over different service provider networks, where the service providers may also support wide area wireless MVNO/MNO 4G/5G services.

More specifically, a network environment as discussed herein includes a communication management resource. The communication management resource detects first wireless connectivity between a mobile communication device and a first wireless network (such as a Wi-Fi™ or other type of network). The communication management resource further provides notification of the first wireless connectivity to a second wireless network (such as a 5G or other type of network). The second wireless network is operative to control forwarding of text messages to the mobile communication device. In response to providing the notification, the communication management resource receives a first text message redirected by the second wireless network to the first wireless network for delivery of the first text message through the first wireless network to the mobile communication device. In such an instance, the mobile communication device is able to receive a respective text message associated with the second wireless network when the mobile communication device is connected to the first wireless network.

In accordance with further examples, detection of the first wireless connectivity includes the communication management resource or other suitable entity receiving a request from the mobile communication device to establish the first wireless connectivity. In one example, the mobile communication device requests to establish the first wireless connectivity in response to a condition in which the mobile communication device is unable to communicate with the second wireless network.

Yet further, operation of the communication management resource providing notification of the first wireless connectivity may include the communication management resource: communicating a network address to the second wireless network, where the network address is assigned to the mobile communication device, the assigned network address supports transmission of communications to the mobile communication device.

Still further, the first wireless network can be configured to support wireless communications via a listen before talk wireless communication protocol; the second wireless network can be configured to support wireless communications via a non-listen before talk wireless communication protocol.

In another example, the communication management resource or other suitable entity receives input from the second wireless network prior to detecting the first wireless connectivity between the mobile communication device and the first wireless network. The received input may indicate an identity of the mobile communication device. The received input can be configured to further indicate that the user of the mobile communication device subscribes to text messaging via the first wireless network.

In yet another example, the communication management resource or other suitable entity is configured to store the received first text message in a buffer for later retrieval by the mobile communication device over the first wireless connectivity.

Further examples herein include the communication management resource communicating the first text message in the first wireless network to a browser application executed on the mobile communication device.

Still further, the first text message can be configured to include credentials for use by the mobile communication device to execute an application.

In another nonlimiting example, the first text message can be configured to include credentials to use an application at the mobile communication device or a computer system in a vicinity of the mobile communication device. The mobile communication device communicates the credentials received in the first text message to a target destination for authentication purposes. The communication management resource or other suitable entity such as an authentication resource can be configured to receive the credentials in a communication transmitted from the mobile communication device over the first wireless connectivity to the first wireless network. As previously discussed, the communications including the credentials may be destined for delivery to a target destination to use the application. The credentials are transmitted to the target destination to complete authentication of the mobile communication device and use of the corresponding application.

In further examples, a first wireless network as discussed herein may be configured to: receive input to register a mobile communication device for message forwarding (such as message forwarding service to support conveyance of communications) to a second wireless network, the mobile communication device may be assigned a first unique identifier value to support conveyance of first communications in the first wireless network; provide notification of the registration of the message forwarding service to a second wireless network; and in response to providing the notification, receive a second unique identifier value from the second wireless network, the second unique identifier value supporting conveyance of second communications in the second wireless network.

In one example, the first unique identifier value is a phone number assigned to the mobile communication device. The second unique identifier value is a network address assigned to the mobile communication device.

In a further example as discussed herein, the communication management resource in the first wireless network produces map information mapping the first unique identifier value to the second unique identifier value. The first wireless network further receives a first message directed for delivery to the mobile communication device, where the first message is assigned the first unique identifier value for delivery of the message by the first wireless network to the mobile communication device. Further, in response to receiving the first message, a communication management resource in the first wireless network maps the first unique identifier value assigned to or in the first message to the second unique identifier value. Via use of the second unique identifier value, the communication management resource in the first wireless network forwards the first message from the first wireless network to the second wireless network for delivery of the first message to the mobile communication device.

In accordance with further examples as discussed herein, the first message may be a text message including credentials for use by the mobile communication device to execute an application.

In another example, the first wireless network and corresponding one or more communication management resources can be configured to detect that the mobile communication device subscribes to the message forwarding service in response to the respective mobile communication device establishing a first wireless communication link with the first wireless network.

Still further examples herein include the first wireless network providing notification of the registration of the mobile communication device to the second wireless network in response to detecting that the respective mobile communication device is wirelessly connected to the first wireless network.

Yet further, as previously discussed, the second wireless network can be configured to support a listen before talk wireless communication protocol to support conveyance of the first communications; the first wireless network can be configured to implement a non-listen before talk wireless communication protocol to convey the second communications.

Note that any of the resources as discussed herein can include one or more computerized devices, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the operations summarized above and disclosed in detail below. One such embodiment comprises a computer program product including computer readable hardware storage or medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One implementation as discussed herein includes a computer readable storage medium and/or system having instructions stored thereon to facilitate wireless connectivity. The instructions, when executed by computer processor hardware, cause the computer processor hardware (such as one or more co-located or disparately processor devices) to: detect first wireless connectivity between a mobile communication device and a first wireless network (such as a Wi-Fi™ network); provide notification of the first wireless connectivity to a second wireless network (such as a 5G or other type of network), the second wireless network operative to control forwarding of text messages to the mobile communication device; and in response to providing the notification, receive a first text message redirected by the second wireless network (such as a 5G or other type of network) to the first wireless network for delivery of the first text message through the first wireless network (such as the Wi-Fi™ network) to the mobile communication device.

The ordering of the steps above has been added for clarity sake. Note that any of the processing steps as discussed herein can be performed in any suitable order.

Other examples of the present disclosure include software programs and/or respective hardware to perform any of the method embodiment steps and operations summarized above and disclosed in detail below.

It is to noted that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting different wireless access and services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment including multiple wireless networks providing a respective communication device access to a remote network as discussed herein.

FIG. 2 is an example diagram illustrating details of multiple wireless networks and corresponding a communication management resource supporting message flow management (such as message redirection) as discussed herein.

FIG. 3 is an example diagram illustrating flow of communications in multiple wireless networks and a corresponding a communication management resource supporting message flow management (such as message redirection) as discussed herein.

FIG. 4 is a diagram illustrating example computer architecture operable to execute one or more operations as discussed herein.

FIG. 5 is an example diagrams illustrating methods as discussed herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

As discussed herein, a communication management resource in a network environment detects first wireless connectivity between a mobile communication device and a first wireless network. The communication management resource provides notification of the first wireless connectivity to a second wireless network. The second wireless network controls forwarding of text messages to the mobile communication device. In response to providing the notification, the communication management resource receives a first text message redirected by the second wireless network to the first wireless network for delivery of the first text message through the first wireless network to the mobile communication device.

Accordingly, the second wireless network and any corresponding communication management entities can be notified of wireless connectivity of the communication device to the first wireless network. When the second wireless network receives a corresponding message, the second wireless network forwards the corresponding message to the communication management resource in the first wireless network for delivery to mobile communication device. In such an instance, the mobile communication device is able to receive communications from the second wireless network even though the mobile communication devices is only connected to the first wireless network because the mobile communication device is unable to connect to the second wireless network.

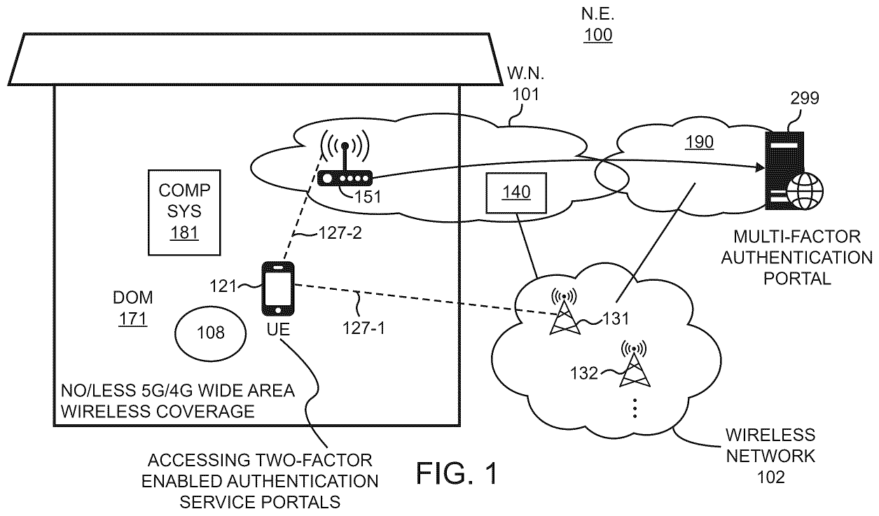

Now, more specifically, FIG. 1 is an example diagram illustrating a network environment including multiple wireless networks providing a respective communication device access to a remote network as discussed herein.

As shown, in this example, network environment 100 includes communication management resource 140, domain 171, wireless network 101, wireless network 102, and network 190.

In this example, the wireless access point 151 is part of wireless network 101, which may include any number of wireless access points. The wireless access point 151 and any of the wireless access point associated with the wireless network 101 may be disposed inside or outside of the domain 171 (such as a building or other entity). In one example, the wireless network 101 supports listen before talk communications, where each of the communication devices using the wireless network 101 compete, via a listen before talk protocol, amongst each other to acquire wireless bandwidth to transmit communications.

Yet further, the wireless base station 131 in this example is part of wireless network 102 and resides outside of the domain 171. Wireless network 102 may include any number of wireless base stations supporting 4G/5G, etc., such as non-listen before talk communications.

Note further that the communication management resource 140 (centralized or distributed) can be disposed in any suitable location in the network environment 100. In one non-limiting example, the communication management resource 140 resides in the wireless network 101. The communication management resource 140 is in communication with any components in the network environment 100 such as components in the wireless network 101, components in the wireless network 102, etc.

As its name suggests, the communication management resource 140 can be configured to manage conveyance of communications through the wireless network 101 to the communication device 121.

Note that any of the resources as discussed herein can be implemented via communication management hardware, software, or a combination of hardware and software. For example, the mobile communication device 121 (and any other communication devices like it in the network environment 100) can be implemented as communication management hardware, communication management software, or a combination of communication management hardware and communication management software; communication management resource 140 can be implemented as communication management hardware, communication management software, or a combination of communication management hardware and communication management software; and so on.

Still further, as its name suggest, the domain 171 may be a building or other suitable entity associated with a corresponding user 108 of the mobile communication device 121.

In the communication system in FIG. 1, the mobile communication device 121 has access to the remote network 190 through wireless network 101 or wireless network 102, depending on availability of such networks. For example, the mobile communication device 121 can be configured to use the wireless network 102 (when available) as a primary means of accessing the remote network 190. When the wireless network 102 (such as a cellular network) is unavailable, the communication device 121 can be configured to use the wireless network 101 to access the remote network 190.

More specifically, the mobile communication device 121 can be configured to initially establish a respective wireless communication link 127-1 with the wireless base station 131 in the wireless network 102. Via the wireless communication link 127-1, the mobile communication device 121 is able to communicate with the remote network through the wireless network 101. For example, the mobile communication device 121 can be configured to wirelessly transmit data packets to the wireless base station 131. The wireless base station 131 forwards those data packets through the wireless network 102 to any specified target entity in the network 190 as specified by the data packets. In a reverse direction, any of the entities in the network 190 can be configured to communicate data packets over the network 190 to wireless network 102 and corresponding wireless base station 131 for delivery to the mobile communication device 121. The wireless network 102 corresponding wireless base station 131 can be configured to transmit those data packets over the wireless communication link 127-1 to the mobile communication device 121.

Additionally, or alternatively, the mobile communication device 121 can be configured to establish a respective wireless communication link 127-2 with the wireless access point 151 in the wireless network 102. Via the wireless communication link 127-2, the mobile communication device 121 has access to the remote network 190. For example, the mobile communication device 121 can be configured to wirelessly transmit data packets to the wireless access point 151 over the wireless communication link 127-2. The wireless access point 151 forwards those data packets through the wireless network 101 to network 190 and any specified target entity in the network 190. In a reverse direction, any of the entities in the network 190 can be configured to communicate data packets over the network through the wireless network 101 to the wireless access point 151. The wireless access point 151 can be configured to transmit those data packets over the wireless communication link 127-2 to the mobile communication device 121.

One use case as described herein includes:
A Wide-area Operator or service provider (WO-A) providing wireless network 102 and corresponding wireless services such as the 5G/4G services through the wireless base station 131, wireless base station 132, and other wireless base stations in the wireless network 102. Note that the service provider operating the wireless network 102 also may be a service provider of Wi-Fi™ services managed for corporate/enterprise.
A subscriber (S1) such as user 108 operating the mobile communication device 121 may have a wireless services subscription from the service provider WO-A associated with the wireless network 102. The subscriber (S1) such as user 108 may work at a corporate office/Enterprise (COE, e.g. Big Shopping Mall), an office building built and covered with high-density walls/thick glass which may limit wireless propagation. In one example, the domain 171 represent a building where the user 108 is employed or where the user 108 at least temporarily resides.
While outside or inside of the domain 171, assume that the user 108 and corresponding communication device 121 initially connect to the remote network 190 through the wireless base station 131 and wireless network 102 providing wireless services such as the wireless communication link 127-1 and access to the remote network 190. The user 108 and corresponding mobile communication device 121 may enter the domain 171 such as a building or other suitable entity. Entering the domain 171 may result in losing the wireless communication link 127-1. The wireless communication link 127-1 also made the terminated because of environmental conditions. This loss of the wireless communication link 127-1 causes the mobile communication device 121 to connect to the wireless network 101 and corresponding wireless access point 151 to communicate with the remote network 190 due to loss of sufficient 5G/4G wireless signals supporting wireless connectivity with the wireless base station 131.
Without the communication management resource 140 and other operations as discussed herein, the subscriber (S1) may try to connect to a web portal, which requires two/multi-factor authentication. Upon regular username/password-based authentication successful, the subscriber S1 (user 108) needs to receive a OTP (a.k. a., one time password) on their mobile device 121 from the serving portal.
However, due to no wireless coverage from mobile operators such as failure of the wireless network 102 to provide the mobile communication device 121 wireless access to the remote network 190, the mobile communication device 121 is unable to receive a text message (such as SMS message) including with a OTP via communications over the wireless network 102. Hence, such a condition prevents the mobile communication device 121 and corresponding user 108 from using certain applications (e.g., NetBanking, Financial transactions like money transfers, Online e-commerce transactions, etc.). To address this issue, the service provider implements the communication management resource 140 to enable communications from the wireless network 102 through the wireless network 101 to the mobile communication device 121 and corresponding user 108 during conditions the wireless network 102 is unavailable.

As a more specific example, a service provider may deploy a managed Wi-Fi TM network (such as wireless network 101) as a cost-effective data offloading alternative with respect to the wireless network 102, where the wireless network 101 allows the user 108 and corresponding communication device 121 access to the remote network 190 such as the Internet as an alternative to the wireless network 102.

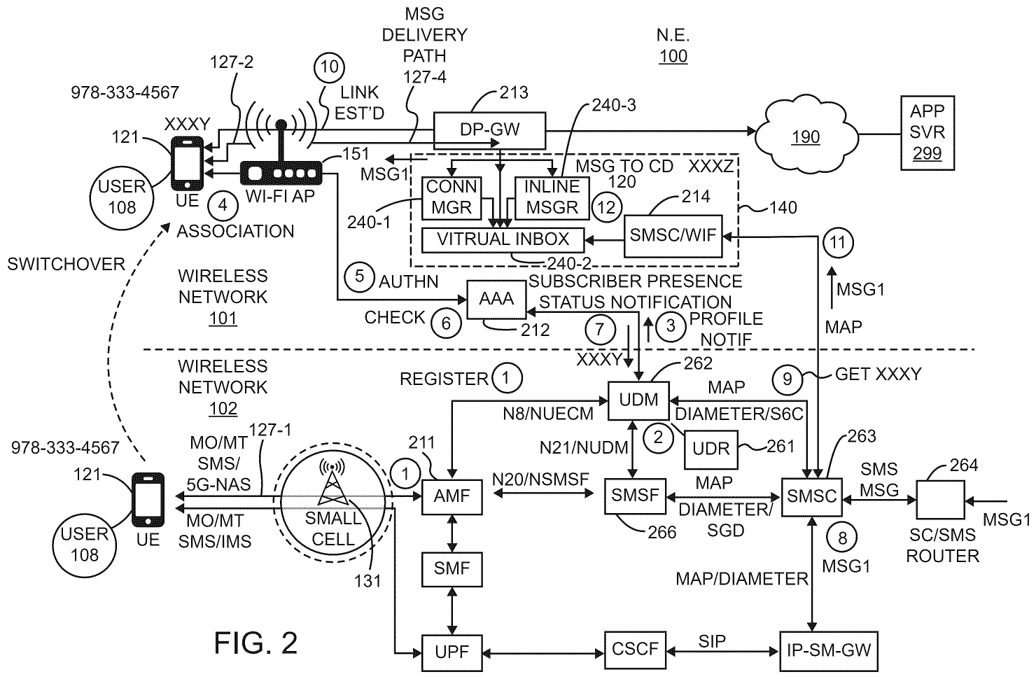

FIG. 2 is an example diagram illustrating details of multiple wireless networks and corresponding a communication management resource supporting message flow management (such as message redirection) as discussed herein.

In this example, the wireless network 101 includes a novel communication management resource 140 supporting delivery of text messages to one or more subscribers such as including the user 108 operating the mobile communication device 121.

As shown, the network environment 100 includes wireless network 101 and wireless network 102.

Wireless network 101 includes wireless access point 151, communication management resource 213 such as a gateway resource, communication management resource 140 such as a message delivery platform, and communication management resource 212 such as authentication server or access manager.

As further shown, a combination of the gateway resource 213 and the communication management resource 212 such as an authentication server control connectivity of the wireless access point 151 and corresponding communication device 121 to the network 190.

For example, via the communication management resource 212 such as an authentication resource, the mobile communication device 121 is authenticated prior to being provided access to the remote network 190 through the wireless access point 151 and the gateway 213. Note that the communication management resource 212 can be implemented as an authentication server (e.g., AAA stands for authentication, authorization, and accounting). AAA is a framework for intelligently controlling access to computer resources, enforcing policies, auditing usage, and providing the information necessary to bill for services.

Subsequent to authentication of the communication device 121 which may include determining that the communication device 121 has a subscription to use the wireless access point 151 and corresponding wireless network 101, the communication management resource 212 can be configured to notify the wireless access point 151 and the communication management resource 213 to provide the mobile communication device 121 access to the remote network 190.

Note further that the application server 299 can be configured to execute a respective application on behalf of the mobile communication device 121 and corresponding user 108. In one example, the user 108 operating the communication device may generate and communicate a request to the application server 299 to execute a respective application on behalf of the user 108. However, in order to be provided access to the executed application of the application server 299, the communication device 121 may be required to provide a one-time password communicated in the message MSG1 to the wireless network 102. In other words, in response to the application server is 299 receiving a request from the communication device to execute a respective application, the application server 299 or other suitable entity can be configured to initiate communication of a message MSG1 such as including one time password information for use by the user 108 or corresponding mobile communication device 121 to provide as authentication credentials for use of the requested application. In this example, assume that the application server 299 initiate communication of the message MSG1 in a text message through the wireless network 102 to the mobile communication device 121 and corresponding user 108.

Assume that the second wireless network one or 2 is unable to forward the message MSG1 to the mobile communication device 121 using the destination identifier 978-333-4567. As further discussed herein, second wireless network 102 can be configured to forward the message MSG1 to the first wireless network 101 and corresponding communication management resource 140, which facilitates conveyance of the message MSG1 to the communication device 121 during conditions in which the communication device 121 is unable to receive the message MSG1 (such as a one-time password to use the requested application) from the wireless network 102.

Yet further, the wireless network 102 includes wireless base station 131, communication management resource 211, communication management resource 262, communication management resource 261, communication management resource 263, communication management resource 264, communication management resource 266, SMF resource, UPF resource, see SCF resource, and IP-SM-GW resource.

In one example, the communication management resource 211 is implemented as an AMF (Access and Mobility Management Function). The Access and Mobility Management Function (AMF) can be configured to receive connection and session related information associated with the communication device 121 and is responsible for handling connection and mobility management tasks.

Communication management resource 261 may be implemented as a so-called UDR (Unified Data Repository). In one example, the communication management resource 261 is a central repository, which is used by the Network Functions in the wireless network 102 to store data.

Communication management resource 262 may be implemented as a so-called UDM (Unified data management) resource. The communication management resource 262 can be configured to manage network user data in a single, centralized element.

Communication management resource 263 may be implemented as an SMSC function. SMSC stands for Short Message Service Center, a part of a mobile network that manages the delivery and routing of SMS messages. SMS stands for—Short Message Service, which is a text messaging service component of most telephone, Internet and mobile device systems.

Communication management resource 264 can be configured as an SC/SMS (Service Center/Short Message Service) router.

Communication management resource 266 can be configured as an SMSF (Short Message Service Function) resource.

As previously discussed, techniques herein include providing a device-agnostic solution for time-sensitive text message delivery (to convey information such as multi-factor authentication codes) over Service provider Wi-Fi™ networks, where service providers also implement wide area wireless MVNO/MNO 4G/5G services.

For example, assume that Operator A (service writer) provides wide-area wireless services over a wireless network 102 such as a 5G network as well as deploys nationwide service provider managed Wi-Fi™ network such as wireless network 101 for data offloading purposes. However, when the user 108 and corresponding communication device 121 move to a location providing only wireless coverage associated with the wireless network 101, the subscriber (100 A) may fail or maybe unable to receive SMS text message delivery services. As discussed herein, the communication management resource 140 such as a Message Delivery Platform (MDP) acts as an interworking network element and integrates with SMS services in wide-area wireless networks (e.g. 5G/4G). The communication management resource 140 such as an MDP supports value-added supplementary features to deliver time-sensitive text messages over the first wireless network 101, store the messages, alert SMS delivery to personal INBOX using in-browser messaging, etc.

Subscriber (S1) such as user 108 subscribes to the 5G wireless services from Operator A and further subscribes to availability of value-added supplementary features offered by the operator A to receive text messages delivered while roaming about the region of wireless coverage provided by the wireless network 101.

### Use Case

Wide-area Operator (WO-A) provides the 5G/4G services, Service provider Wi-Fi on outdoor and managed Wi-Fi™ for corporate/enterprise.
Subscriber (S1) has a wireless services subscription from the WO-A. Subscriber (S1) works at the Corporate Office/Enterprise (COE) or visits aBig Shopping Mall for shopping, where these buildings are built and covered with high-density walls/thick glass which may limit wireless propagation.
Subscriber (S1) entered the domain 171 such as a COE building, connected to the internet using Wi-Fi provided by WO-A due to no/less 5G/4G wireless signals.
Subscriber (S1) tries to connect to the portal associated with the application server 299, which requires two/multi-factor authentication, upon regular username/password-based authentication successful, user 108 needs to receive OTP on his mobile from the serving portal.
However, due to no wireless coverage from mobile operators in the wireless network 102, the communication device 121 potentially fails to receive the message MSG1 such as a SMS message with a one-time password.
With value-added services offered by the operator for subscribers connected to managed Wi-Fi™, the operator's MDP (Message Delivery Platform) acts as receiving SMSC.
The messages received by the communication management resource 140 and corresponding functions can be retrieved or provide delivery of messages in any suitable manner such as below:
   The communication management resource 140 may implement the Connection manager 240-1 to the display the message MSG1 on the mobile communication device 121 as a notification message.
   The communication management resource 140 may implement in-line messenger function 240-3 to display the message MSG1 as an in-browser message notification with OTP content.
   The communication management resource 140 may implement the virtual inbox function 240-2, which enables retrieval of the message MSG1 by the communication device 121 from the communication management resource 140 for display on the display screen of the mobile communication device 121.

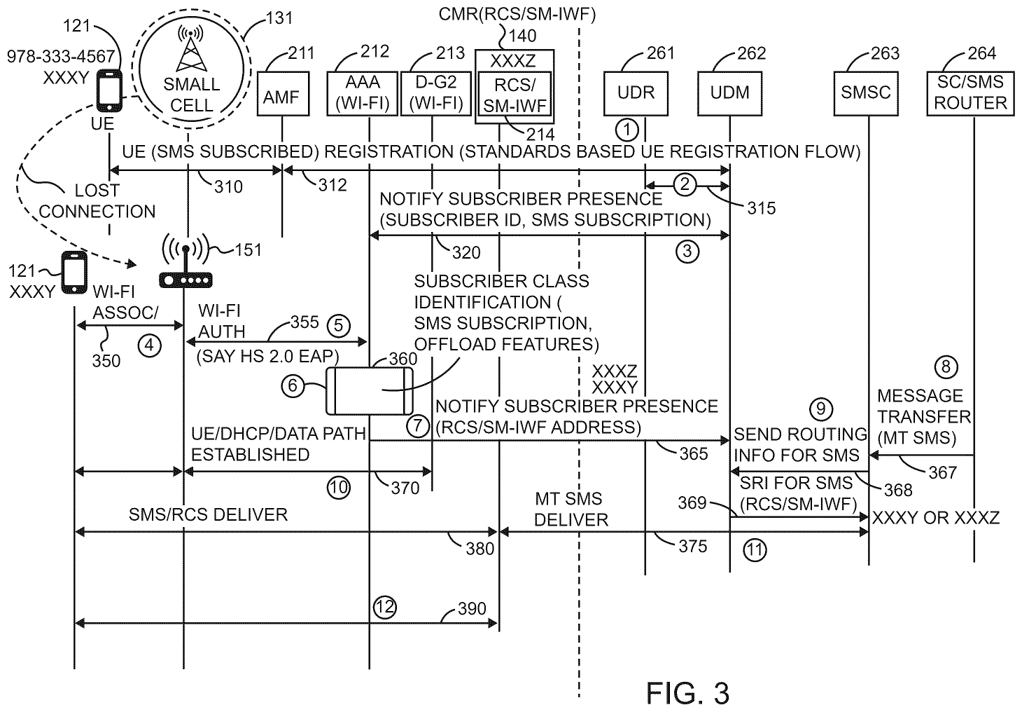

Thus, in the call flow as discussed herein (see FIG. 3 is well), the wireless coverage provided by the wireless network 101 is collocated with respect to the wireless coverage provided by the wireless base station 131 and corresponding wireless network 102. When communication device 121 is attached to 5G/4G cell site respective core network element, the wireless network 102 and corresponding communication management resource 262 notify the communication management resource 212 (such as neighbor Wi-Fi™ Authentication Server or AAA) in a wireless network 101 about the presence of the mobile communication device 121 in a vicinity of the region of wireless coverage provided by the wireless network 101 and corresponding wireless access point 151.

When the respective subscriber is attached to the wireless access point 151 (where no wireless coverage is available to the communication device 121 from the wireless network 102), the service provider AP may perform the user authentication.

At the time of authentication of the mobile communication device 121 to the wireless network 102, the communication management resource 212 checks a respective the subscriber service or subscription services to be provided by the wireless network 101 and wireless network 102 to the mobile communication device 121 and corresponding user 108.

If a determined subscription associated with the communication device 121 and corresponding user 108 indicates to allow the mobile communication device 121 to receive SMS (Short Message Service) messages and corresponding redirection of text messages from the second wireless network 102 to the first wireless network 101 via the communication management resource 140, then the communication management resource 212 updates the wireless network 102 and corresponding 5G/4G core network for MT-SMS delivery of text messages such as message MSG1 to the communication management resource 140.

Thus, if there are any MT-SMS messages directed to the mobile communication device 121, they will be delivered to mobile communication device 121 and corresponding user 108 via the communication management resource 140 (MDP/SMSC).

As further discussed herein, and as previously discussed, the communication management resource 140 can be configured to provide any text messages to the communication device 121 in any suitable manner.

FIG. 3 is an example diagram illustrating flow of communications in multiple wireless networks and a corresponding a communication management resource supporting message flow management (such as message redirection) as discussed herein.

The following discussion references both FIGS. 2 and 3.

In this example, assume that the mobile communication device 121 is assigned a unique phone number such as 978-333-4567 for routing of text communications to the mobile communication device via the wireless network 102. The mobile communication device 121 ids also assigned unique network address XXX1 for routing of communications to the mobile communication device 121 in the wireless network 101.

As previously discussed, using the phone number 978-333-4567, the mobile communication device 121 establishes the wireless communication link 127-1 between the mobile communication device 121 and the wireless base station 131 in operation #1. Via communications 310 over the wireless communication link 127-1 associated with operation #1, the communication device 121 registers with the communication management resource 211 (such as AMF or Access and Mobility Management Function) in wireless network 102. Further, in operation #1, in furtherance of registration, the communication management resource 211 can be configured to communicate with the communication management resource 262 (such as a UDM or Unified Data Management function) in wireless network 102 via communications 312 to register the mobile communication device 121 for receipt/forwarding of text messages.

In response to receiving the registration, the communication management resource 262 provides notification (such as via communications 315) of the text message registration associated with the mobile communication device 121 to the communication management resource 261 (such as a UDR or Unified Data Repository function).

As further shown, in processing operation #3, via the communications 320 (such as presence notification indicating information such as an identifier of the communication device XXXY or identity of the user 108, SMS or Short Message Service subscription, etc.), the communication management resource 262 transmits a notification of subscriber presence in the communications 320 to the communication management resource 212 (such as AAA or authentication server) associated with the wireless network 101.

Further in this example, assume that the mobile communication device enters the domain 171, resulting in loss of the wireless communication link 127-1. The loss of the wireless communication link 127-1 prevents the mobile communication device 121 from receiving password information (such as in MSG1) to use a respective application either on the mobile communication device 121 itself or the computer system 181 or other entity operated by the user 108.

In response to losing the wireless communication link 127-1, or simply loss of access to the network 190 via wireless network 102, the mobile communication device 121 establishes a wireless communication link 127-2 between the mobile communication device 121 and the wireless access point 151 in the wireless network 101.

As further shown in FIG. 3, establishment of the wireless communication link 127-2 includes operation #4 (such as association) in which the mobile communication device 121 connects to the wireless access point 151.

In response to the association, via communications 355 with the communication management resource 212 (such as an authentication server associated with the wireless access point 151 and corresponding wireless network 101) in processing operation #5, the wireless access point 151 performs authentication of the mobile communication device 121 and corresponding user 108 for use of the wireless network 101.

In processing operation #6, the communication management resource 212 such as an authentication server or other suitable entity determines subscriber class identification information associated with the user 108 (subscriber) such as SMS offload rules associated with the user 108 and corresponding mobile communication device 121. In this example, via processing operation #6, assume that the communication management resource 212 learns that the user 108 and corresponding communication device 121 subscribe to forwarding of text message notifications from the wireless network 102 through the wireless network 101 to the mobile communication device 121 or user 108 such as during conditions in which the message MSG1 is undeliverable to the mobile communication device 121 through only the wireless network 102.

In response to detecting that the user 108 and corresponding communication device 121 are connected to the wireless network 101 and corresponding wireless access point 151, in processing operation #7, the communication management resource 212 transmits communications 365 to the communication management resource 262. In one example, the communications 365 indicate a network address associated with the corresponding mobile communication device 121 and user 108. For example, the communication 365 can be configured to indicate a network address XXXY has been assigned for communication of messages to the mobile communication device 121 through the wireless network 101. Additionally, or alternatively, the communications 365 in operation #7 may indicate an identity and/or network address associated with the communication management resource 140 supporting conveyance of messages received from the second wireless network 102 for delivery to the mobile communication device 121 over the first wireless network 101.

In processing operation #8 and corresponding communications 367, the communication management resource 264 such as a text message router receives a message MSG1 directed to the mobile communication device 121 assigned the identity 978-333-4567. In response to receiving the message MSG1, via the communications 367, the communication management resource 264 transmits the received message MSG1 to the communication management resource 263 such as via a message transfer protocol. For example, MT messages (message MSG1) are SMS text messages sent from an application or system to an end user's mobile phone (communication device 121).

In processing operation #9, the communication management resource 263 transmits communications 368 to the communication management resource 262. In one example, the communications 368 include a request for routing information associated with the message MSG1 directed for delivery to the mobile communication device 121 and identity information 978-333-4567.

As further shown, via communications 369 from the communication management resource 262 to the communication management resource 263, the communication management resource 262 provides notification of an SRI for SMS messaging to the communication management resource 140. In one example, SRI associated with communications 369 stands for Send Routing Information, and is a MAP message to request routing information for a mobile subscriber. Accordingly, via communications 369, the communication management resource 263 is notified of routing information (such as network address XXXY) how to forward message MSG1 (and potentially other messages directed to the mobile communication device 121) from the wireless network 102 to the wireless network 101 and corresponding communication device 121. The communication management resource 263 can be configured to map the identity 978-333-4567 of the message MSG1 to the alternate destination network address XXXY or network address of the communication management resource 140. Thus, the routing information in the communication 367 may indicate the network address XXXY of the mobile communication device 121. The routing information may also indicate a network address of the communication management resource 140 as a destination in which to deliver the message MSG1 for subsequent delivery to the target mobile communication device 121.

Accordingly, the communication management resource 263 or other suitable entity can be configured to maintain a respective map between: i) the unique identifier value (such as a phone #) 978-333-4567 assigned to the mobile communication device 121 and the wireless network 102, and ii) the network address XXXY assigned to the mobile communication device 121 for use in the wireless network 101.

In processing operation #10, via communications 370, the mobile communication device 121 completes establishing the wireless communication link 127-2, where the wireless access point 151 provides notification of the established wireless communication link 127-2 to the communication management resource 213 such as a gateway resource controlling connectivity of the wireless access point 151 and the communication device 121 to the network 190. In other words, because the mobile communication device 121 is authenticated to use the wireless communication link 127-2, the communication management resource 213 is notified that the mobile communication device 121 should be provided access to the network 190.

In processing operation #11, via communications 375, the communication management resource 263 forwards the respective message MSG1 to the communication management resource 140 in furtherance of delivering the message MSG1 to the network address XXXY. For example, the message MSG1 may be tagged with the unique identifier value (978-333-4567) indicating that the message MSG1 is directed for delivery to the mobile communication device 121. Via the mapping information available to the communication management resource 263, the communication management resource 263 maps the unique identifier value (978-333-4567) associated with the message MSG1 to the network address XXXY. Accordingly, the communication management resource 263 forwards the message to the communication management resource 140 for delivery to the communication device 121.

In one example, via communications 380, the communication management resource 140 provides notification of the message MSG1 through the wireless access point 151 to the mobile communication device 121. The notification associated with communications 380 may include message MSG1 or an indication of the message MSG1. In the latter instance, after receiving notification of the message availability, the mobile communication device 121 communicates over the wireless communication link 127-2 and through the wireless access point 151 to the communication management resource 140 to retrieve the message MSG1 as discussed below.

The communication management resource 140 can be configured to deliver the message MSG1 in any suitable manner. For example, in processing operation #12, via communications 390, the communication management resource 140 communicates the message MSG1 to the wireless access point 151. The wireless access point 151 wirelessly communicates the message MSG1 to the mobile communication device 121.

For example, the communication management resource 140 can be configured to include the communication management resource 214 such as a short message service center associated with the wireless network 101. The communication management resource 213 of the communication management resource 140 receives the message MSG1 and forwards it to one or more of the message functions such as connection manager function 240-1, virtual inbox function 240-2, and/or the in-line messenger function 240-3.

In one implementation, the connection manager function 240-1 can be configured to manage display of the message MSG1 on a display screen of the communication device 121 as a notification message.

In another implementation, via the virtual inbox function 240-2, the communication management resource 140 can be configured to display the message MSG1 received for delivery to the communication device 121 as an in-browser message notification about the received message and stored in the user's personal inbox 240-2 disposed in the communication management resource 140. The inbox 240-2 associated with the user 108 is accessible for retrieval of the message MSG1 by the communication device 120 and corresponding user 108.

In one implementation, via the in-line message function 240-3, the communication management resource 140 can be configured to display the message MSG1 as an in-browser message notification with OTP content on a display screen of the mobile communication device 121. For example, the user 100 and operating the mobile communication device 121 may be attempting to execute a respective application either on the mobile communication device itself or in the remote network 190. Use of the corresponding application may require a one-time password present in the message MSG1 provided by the application server 299 to use the application executed on the application server 299. After establishing the respective wireless communication link 127-2, the management resource associated with controlling use of the application may forward a respective message MSG1 including a one-time password (such as PASSWORDTEMP1) in response to detecting a request by the user 108 and or communication device 121 requesting to execute the application. The user 108 may read the password such as PASSWORDTEMP1 on the display screen of the mobile communication device 121 and input the password received in the message to a query function associated with the application. After supplying the appropriate password, the user 108 and corresponding communication device 121 are now able to use the application.

### In Summary

1. In the above flowchart (call flow in FIG. 3 and network configuration of FIG. 2), wireless coverage is provided by the wireless network 101 with respect to the wireless network 102 such as a Wide-Area Wireless cell site including the wireless base station 131. When the user 108 and corresponding communication device 121 attached to wireless base station 131 such as a 5G/4G cell site, the respective core network element such as the communication management resource 262 in processing operation #3 notifies a neighbor communication management resource 212 such as a Wi-Fi Authentication Server (AAA) about the presence of potential roaming of the respective user 108 and corresponding communication device 121 into the wireless network 101.
2. When the respective user 108 and corresponding communication device 121 establish the wireless communication link 127-2 with the wireless access point 151 (such as where no 5G/4G wireless coverage), the wireless network service provider operating the wireless access point 151 performs the user authentication with the communication management resource 212.
3. At the time of authenticating the mobile communication device 121 and corresponding user 108 with the communication management resource 212 (authentication server) in processing operation #5, the communication management resource 212 checks a subscriber service subscription associated with the user 108 and/or the mobile communication device 121. During a detected condition in which the subscription information associated with the corresponding user 108 and mobile communication device 121 indicates to allow the subscriber to receive SMS (Short Message Service) messages over first wireless network 101 via an MDP function (communication management resource 140), the communication management resource 212 (such as a AAA server) updates the wireless network 102 such as a 5G/4G core network for MT-SMS delivery using the wireless network (101) operator with a respective SMSC network address (such as XXXZ) associated with the communication management resource 140 and, more specifically, potentially the communication management resource 214.
4. If there is any MT-SMS message destined for delivery to the subscriber (108), then that message such as message MSG1 is delivered to the communication management resource 140 and corresponding communication management resource 214 (such as MDP/SMSC) at network address XXXZ for subsequent delivery to the network address XXXY assigned to the communication device 121.
5. The message MSG1 destined for delivery to the mobile communication device 121 can be delivered or made available by the communication management resource 140 in any suitable manner. For example, the communication management resource 140 such as MDP/SMSC can be configured to support any of the following delivery options in order to deliver the respective SMS message (such as message MSG1) to user 108 corresponding communication device 121 via the first wireless network 101.
   The service provider or communication management resource 140 can be configured to include a respective connection manager 240-1 managing the display of the message MSG1 on a display screen of the communication device 121 as a notification message.
   Via the in-line message are function 240-3, the communication management resource 140 can be configured to display the message MSG1 as an in-browser message notification with OTP content on a display screen of the mobile communication device 121. For example, the user 100 and operating the mobile communication device 121 may be attempting to execute a respective application either on the mobile communication device itself or in the remote network 190. Use of the corresponding application may require a one-time password present in the message MSG1. After establishing the respective wireless communication link 127-2, the management resource associated with controlling use of the application may forward a respective message MSG1 including a one-time password (such as PASSWORDTEMP1) in response to detecting a request by the user 108 and or communication device 121 requesting to execute the application. The user 108 may read the password such as PASSWORDTEMP1 on the display screen and input the password received in the message to a query function associated with the application. After supplying the appropriate password through the mobile communication device 121 and corresponding wireless network to the application server 299 or other suitable entity, the user 100 and corresponding communication device 121 is then able to use the application.
   Via the virtual inbox function 240-2, the communication management resource 140 can be configured to display the message MSG1 received for delivery to the communication device 121 an in-browser message notification about the received message and stored in the user's personal inbox 240-2 disposed in the communication management resource 140. The inbox 240-2 is accessible for retrieval by the communication device 121 and corresponding user 108.

Thus, from one perspective, the communication management resource 140 detects first wireless connectivity such as wireless communication link 127-2 between the mobile communication device 121 and the wireless access point 151 and/or gateway communication management resource 213 in the first wireless network 101. The wireless access point 151 or other suitable entity provides notification of the first wireless connectivity (wireless communication link 127-2) to the communication management resource 262 (such as UDM) in the second wireless network 102. One or more resources in the second wireless network 102 control forwarding of text messages (such as MSG1) through the communication management resource 140 to the mobile communication device 121. In response to providing the notification of the presence of the communication device 121 connected to the wireless network 101, the communication management resource 140 receives a first text message such as message MSG1 redirected by the second wireless network 102 to the first wireless network 101 for delivery of the first text message MSG1 through the first wireless network 101 to the communication management resource 140 and mobile communication device 121.

Detecting the first wireless connectivity such as the wireless communication link 127-2 may include the communication management resource 140 receiving a request from the mobile communication device 121 to establish the first wireless connectivity (wireless communication link 127-2). The mobile communication device 121 may request to establish the wireless connectivity (127-2) in response to a condition in which the mobile communication device 121 is unable to communicate with the wireless base station 131 in the second wireless network 102.

Still further, as previously discussed, the first wireless network 101 can be configured to support wireless communications via a listen before talk wireless communication protocol such as Wi-Fi™; the second wireless network 102 can be configured to support wireless communications via a non-listen before talk wireless communication protocol such as LTE (Long Term Evolution), 4G, 5G, etc.

In another example, the communication management resource 140 or other suitable entity receives input (such as communications 365 or other communications) from the second wireless network 102 prior to or after detecting the wireless connectivity (127-2) between the mobile communication device 121 and the first wireless network 101. Note that the received input may indicate an identity (such as network address XXXY) of the mobile communication device 121 or an identity such as network address XXXZ of the communication management resource 140 for redirection of messages. The received input can be configured to further indicate that the user 108 of the mobile communication device 121 subscribes to text messaging via the wireless network 102.

In yet another example, the communication management resource 140 or other suitable entity can be configured to store the received text message MSG1 in a buffer (such as the inbox 240-2) for later retrieval by the mobile communication device 121 over the wireless connectivity (127-2).

Further examples herein include the communication management resource 140 or other suitable entity communicating the first text message MSG1 in or through the wireless access point 151 in the wireless network 101 to a browser application executed on the mobile communication device 121.

Still further, the first text message MSG1 can be configured to include any suitable information such as credentials for use by the mobile communication device 121 to execute an application associated with the user 108 or the communication device 121 or the computer system 181.

In yet a further example, the message MSG1 can be configured to include credentials to use an application at or associated with the mobile communication device 121. The communication management resource 140 or other suitable entity can be configured to: receive the credentials in a communication transmitted from the mobile communication device 121 over the first wireless connectivity (127-2). The communications may be destined for delivery to a target destination to use the application. The communication management resource or other suitable entity can be configured to transmit the credentials from the first wireless network to the target destination.

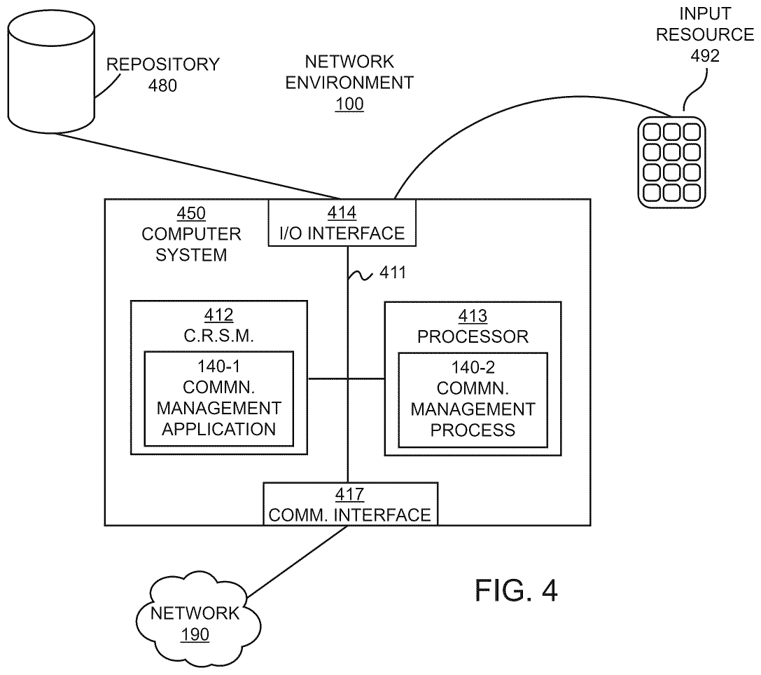

FIG. 4 is an example block diagram of a computer system for implementing any of the operations as previously discussed according to embodiments herein.

Note that any of the resources (such as communication management resource 140, communication management resource 214, function 240-1, function 240-2, function 240-3, etc.) as discussed herein can be configured to include computer processor hardware, analog/digital circuitry, and/or corresponding executable instructions to carry out the different operations as discussed herein.

As shown, computer system 450 of the present example includes an interconnect 411 that couples computer readable storage media 412 such as a non-transitory type of media (i.e., any type of hardware storage medium) in which digital information can be stored and retrieved, a processor 413, I/O interface 414, and a communications interface 417.

I/O interface(s) 414 supports connectivity to repository 480 and input resource 492.

Computer readable storage medium 412 (such as computer-readable storage hardware) can be any hardware storage device such as memory, optical storage, hard drive, floppy disk, etc. In one embodiment, the computer readable storage medium 412 stores instructions and/or data.

As shown, computer readable storage media 412 can be encoded with communication management application 140-1 (e.g., including instructions) to carry out any of the operations as discussed herein.

During operation of one example, processor 413 accesses computer readable storage media 412 via the use of interconnect 411 in order to launch, run, execute, interpret or otherwise perform the instructions in management application 140-1 stored on computer readable storage medium 412. Execution of the management application 140-1 produces management process 140-2 to carry out any of the operations and/or processes as discussed herein.

Those skilled in the art will understand that the computer system 450 can include other processes and/or software and hardware components, such as an operating system that controls allocation and use of hardware resources to management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 450 may reside at any location or can be included in any suitable resource in any network environment to implement functionality as discussed herein.

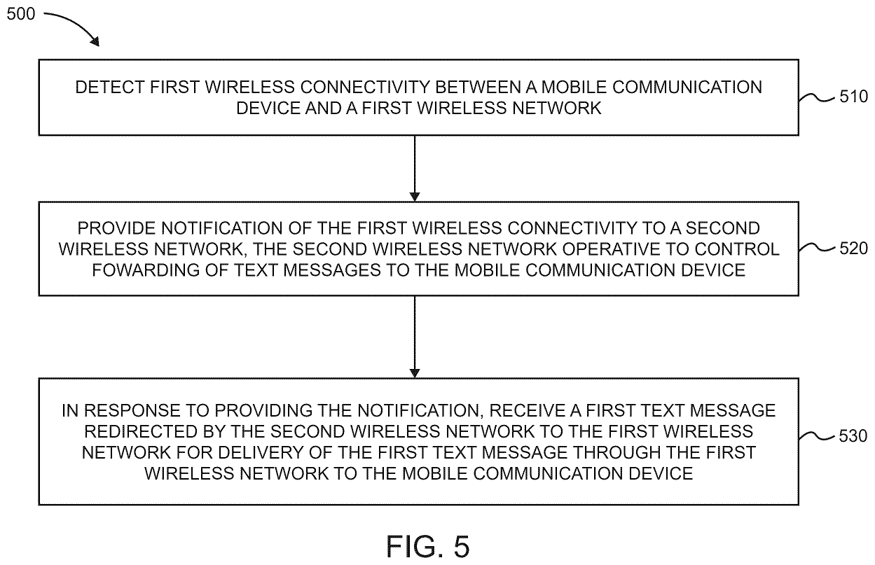

Functionality supported by the different resources will now be discussed via flowcharts in FIG. 5. Note that the steps in the flowcharts below can be executed in any suitable order.

FIG. 5 is a flowchart 500 illustrating an example method according to embodiments herein. Note that there will be some overlap with respect to concepts as discussed above.

In processing operation 510, the communication management resource 140 detects first wireless connectivity between a mobile communication device and a first wireless network.

In processing operation 520, the communication management resource 140 provides notification of the first wireless connectivity to a second wireless network, the second wireless network operative to control forwarding of text messages to the mobile communication device.

In processing operation 530, in response to providing the notification, the communication management resource 140 receives a first text message redirected by the second wireless network to the first wireless network for delivery of the first text message through the first wireless network to the mobile communication device.

Note again that techniques herein are well suited to support delivery of communications and multiple networks and, more specifically, redirection of communications from one network to another for delivery to a particular communication device. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

I claim:

1. In a network environment including a first wireless network and a second wireless network, a method comprising:
detecting first wireless connectivity between a mobile communication device and the second wireless network;
providing notification of the first wireless connectivity to the first wireless network, the second wireless network operative to control forwarding of text messages to the mobile communication device; and
in response to providing the notification, receiving a first text message redirected by the first wireless network to the second wireless network for delivery of the first text message through the second wireless network to the mobile communication device.

2. The method as in claim 1, wherein detecting the first wireless connectivity includes: receiving a request from the mobile communication device to establish the first wireless connectivity; and
wherein the mobile communication device requests to establish the first wireless connectivity in response to a condition in which the mobile communication device is unable to communicate with the first wireless network.

3. The method as in claim 1, wherein providing notification of the first wireless connectivity includes:
communicating a network address to the first wireless network, the network address supporting transmission of communications to the mobile communication device in the second wireless network.

4. The method as in claim 1, wherein the second wireless network supports wireless communications via a listen before talk wireless communication protocol; and
wherein the first wireless network supports wireless communications via a non-listen before talk wireless communication protocol.

5. The method as in claim 1 further comprising:
receiving input from the first wireless network prior to detecting the first wireless connectivity between the mobile communication device and the second wireless network, the received input indicating an identity of the mobile communication device.

6. The method as in claim 5, wherein the received input further indicates that a user of the mobile communication device subscribes to text messaging via the second wireless network.

7. The method as in claim 1 further comprising:
storing the received first text message in a buffer for later retrieval by the mobile communication device over the first wireless connectivity.

8. The method as in claim 1 further comprising:
communicating the first text message from a communication management resource in the second wireless network to a browser application executed on the mobile communication device.

9. The method as in claim 1, wherein the first text message includes credentials for use by the mobile communication device to execute an application.

10. The method as in claim 1, wherein the first text message includes credentials to use an application at the mobile communication device, the method further comprising:
receiving the credentials in a communication transmitted from the mobile communication device over the first wireless connectivity to the second wireless network, the communications destined for delivery to a target destination to use the application; and
transmitting the credentials from the second wireless network to the target destination.

11. In a network environment including a first wireless network and a second wireless network, a system comprising:
communication management hardware operative to:
detect first wireless connectivity between a mobile communication device and the second wireless network;
provide notification of the first wireless connectivity to the first wireless network, the first wireless network operative to control forwarding of text messages to the mobile communication device; and
in response to providing the notification, receive a first text message redirected by the first wireless network to the second wireless network for delivery of the first text message through the second wireless network to the mobile communication device.

12. The system as in claim 11, wherein the communication management resource is further operative to receive a request from the mobile communication device to establish the first wireless connectivity; and
wherein the mobile communication device requests to establish the first wireless connectivity in response to a condition in which the mobile communication device is unable to communicate with the first wireless network.

13. The system as in claim 11, wherein the communication management resource is further operative to:
communicate a network address to the first wireless network, the network address supporting transmission of communications to the mobile communication device in the second wireless network.

14. The system as in claim 11, wherein the second wireless network supports wireless communications via a listen before talk wireless communication protocol; and
wherein the first wireless network supports wireless communications via a non-listen before talk wireless communication protocol.

15. The system as in claim 11, wherein the communication management resource is further operative to:
receive input from the first wireless network prior to detecting the first wireless connectivity between the mobile communication device and the second wireless network, the received input indicating an identity of the mobile communication device.

16. The system as in claim 15, wherein the received input further indicates that a user of the mobile communication device subscribes to text messaging via the second wireless network.

17. The system as in claim 11, wherein the communication management resource is further operative to
store the received first text message in a buffer for later retrieval by the mobile communication device over the first wireless connectivity.

18. The system as in claim 11, wherein the communication management resource is further operative to:
communicate the first text message from a communication management resource in the second wireless network to a browser application executed on the mobile communication device.

19. The system as in claim 11, wherein the first text message includes credentials for use by the mobile communication device to execute an application.

20. The system as in claim 11, wherein the first text message includes credentials to use an application at the mobile communication device; and
wherein the communication management resource is further operative to
receive the credentials in a communication transmitted from the mobile communication device over the first wireless connectivity to the second wireless network, the communications destined for delivery to a target destination to use the application; and
transmit the credentials from the first wireless network to the target destination.

21. Computer-readable storage hardware having instructions stored thereon, the instructions, when carried out by computer processor hardware, cause the computer processor hardware to:
detect first wireless connectivity between a mobile communication device and a second wireless network;
provide notification of the first wireless connectivity to a first wireless network, the first wireless network operative to control forwarding of text messages to the mobile communication device; and
in response to providing the notification, receive a first text message redirected by the first wireless network to the second wireless network for delivery of the first text message through the second wireless network to the mobile communication device.

22. A method comprising:
via a first wireless network:
receiving input to register a mobile communication device for message forwarding to a second wireless network, the mobile communication device assigned a first unique identifier value to support first communications in the first wireless network;
providing notification of the registration to a second wireless network; and
in response to providing the notification, receiving a second unique identifier value from the second wireless network, the second unique identifier value supporting conveyance of second communications in the second wireless network.

23. The method as in claim 22, wherein the first unique identifier value is a phone number assigned to the mobile communication device; and
wherein the second unique identifier value is a network address assigned to the mobile communication device.

24. The method as in claim 23 further comprising:
producing map information mapping the first unique identifier value to the second unique identifier value.

25. The method as in claim 24 further comprising:
via the first wireless network, receiving a first message directed for delivery to the mobile communication device, the first message assigned the first unique identifier value for delivery of the message by the first wireless network to the mobile communication device.

26. The method as in claim 25 further comprising:
in response to receiving the first message, via the map information, mapping the first unique identifier value assigned to the first message to the second unique identifier value; and
via the second unique identifier value, forwarding the first message from the first wireless network to the second wireless network for delivery of the first message to the mobile communication device.

27. The method as in claim 22, wherein the first message is a text message including credentials for use by the mobile communication device to execute an application.

28. The method as in claim 22, wherein registering the mobile communication device includes:
detecting that the mobile communication device subscribes to the message forwarding during a condition in which the mobile communication device establishes a first wireless communication link with the first wireless network.

29. The method as in claim 22 further comprising:
providing the notification of the registration to the second wireless network in response to detecting that the mobile communication device is wirelessly connected to the first wireless network.

30. The method as in claim 22, wherein the second wireless network supports a listen before talk wireless communication protocol to convey the first communications; and
wherein the first wireless network a non-listen before talk wireless communication protocol to convey the second communications.
